(19) United States
(12) Patent Application Publication
(10) Pub. No.: US 2019/0034152 A1
(43) Pub. Date: Jan. 31, 2019

(54) AUTOMATIC CONFIGURATION OF DISPLAY SETTINGS BASED ON A DETECTED LAYOUT OF MULTIPLE DISPLAY DEVICES

(71) Applicant: Lenovo Enterprise Solutions (Singapore) Pte. Ltd., Singapore (SG)

(72) Inventor: Youssef Jouad, Durham, NC (US)

(21) Appl. No.: 15/658,926

(22) Filed: Jul. 25, 2017

(51) Int. Cl. G06F 3/14

(52) U.S. Cl. CPC G06F 3/1446

(57) ABSTRACT

An apparatus includes a storage device for storing program instructions and a processor for processing the program instructions to receive orientation data from a first display device, receive data from the first display device indicating detection of a second display device in a position adjacent to a first edge of the first display device, determine a layout of the first and second display devices based upon the orientation of the first display and the adjacent position of the second display device relative to the first display device, and automatically configure operating system display settings to identify that the first and second display devices are physically arranged according to the determined layout. The display device may include an orientation sensor and a plurality of detectors spaced apart about a central portion of a display screen at predetermined positions, each detector for detecting presence of an adjacent display device.

### BACKGROUND

The present disclosure relates to setup and configuration of a computer system having multiple display devices.

### BACKGROUND OF THE RELATED ART

A computer may be coupled to a variety of familiar input output devices, such as a mouse, keyboard, speakers and display device. A display device, also frequently referred to as a monitor, includes a display screen that reproduces images according to signals received from the computer. A modern display screen may, for example, include thin film transistor liquid crystal display (TFT-LCD) with LED backlighting.

Many computer users have found that they can increase their productivity by using multiple display devices. Accordingly, a larger number of application windows may be displayed at the same time and facilitate greater user interaction with the computer. However, implementing multiple display devices requires that the computer include a video graphics adapter card that supports multiple display devices. In addition to the hardware setup, the user must instruct an operating system of the computer about the physical layout of the display devices.

### BRIEF SUMMARY

One embodiment provides a display device comprising a display screen for displaying images received from a computer, an orientation sensor coupled to the display screen for determining a current orientation of the display screen, and a plurality of detectors spaced apart about a central portion of the display screen at predetermined positions, each detector for detecting presence of an adjacent display device. The display device further comprises a processor in communication with the orientation sensor, the plurality of detectors, and an input/output port, the processor for sending the current orientation of the display screen, sending an indication of which detector has detected the presence of the adjacent display device, and receiving the images from the computer.

Another embodiment provides an apparatus comprising at least one storage device for storing program instructions and at least one processor for processing the program instructions to: receive data from a first display device indicating an orientation of the first display device, receive data from the first display device indicating detection of a second display device in a position adjacent to a first edge of the first display device, determine a layout of the first and second display devices based upon the orientation of the first display and the adjacent position of the second display device relative to the first display device, and automatically configure operating system display settings to identify that the first and second display devices are physically arranged according to the determined layout.

Yet another embodiment provides a non-transitory computer program product comprising computer readable storage media having program instructions embodied therewith, the program instructions executable by a processor to: receive data from a first display device indicating an orientation of the first display device, receive data from the first display device indicating detection of a second display device in a position adjacent to a first edge of the first display device, determine a layout of the first and second display devices based upon the orientation of the first display device and the adjacent position of the second display device relative to the first display device, and automatically configure operating system display settings to identify that the first and second display devices are physically arranged according to the determined layout.

### BRIEF DESCRIPTION OF THE SEVERAL VIEWS OF THE DRAWINGS

FIG. 1 is a diagram of a system including a computer coupled to first and second display devices.

FIGS. 2A-2D are diagrams of a display device in various orientations.

FIGS. 3A and 3B include a diagram of a first layout of two display devices and a configuration table representing the layout of the two display devices.

FIGS. 4A and 4B include a diagram of a second layout of two display devices and a configuration table representing the layout of the two display devices.

FIGS. 5A and 5B include a diagram of a layout of three display devices and a configuration table representing the layout of the three display devices.

FIGS. 6A and 6B include a diagram of a layout of four display devices and a configuration table representing the layout of the four display devices.

FIG. 7 is a flowchart of a method according to one embodiment.

### DETAILED DESCRIPTION

One embodiment provides a display device comprising a display screen for displaying images received from a computer, an orientation sensor coupled to the display screen for determining a current orientation of the display screen, and a plurality of detectors spaced apart about a central portion of the display screen at predetermined positions, each detector for detecting presence of an adjacent display device. The display device further comprises a processor in communication with the orientation sensor, the plurality of detectors, and an input/output device, the processor for sending the current orientation of the display screen, sending an indication of which detector has detected the presence of the adjacent display device, and receiving the images from the computer.

A display device is an output device which displays the information in pictorial form. A display device usually comprises a display screen, control circuitry, a physical casing, and a power supply. The display screen in a modern display device may, for example, be a thin film transistor liquid crystal display (TFT-LCD) with LED backlighting. Furthermore, a display device may be coupled to a computer via a video graphics array (VGA), digital visual interface (DVI), high-definition multimedia interface (HDMI), DisplayPort, Thunderbolt, low-voltage differential signaling (LVDS) or other proprietary connectors, signals or standards now in existence or to yet be developed.

The plurality of detectors are spaced apart about a central portion of the display screen, and are preferably disposed along a perimeter of the display screen. For example, the display device may have a rectangular display screen and each of the plurality of detectors may be disposed adjacent one of the edges of the rectangular display screen. The detectors are non-contact detectors, such as near field communication (NFC) devices or ultra high frequency (UHF) radio wave devices. Bluetooth™ is one example of a wireless technology standard for exchanging data over short distances using UHF radio waves.

The display device may, without limitation, send its capabilities to the computer using the Extended Display Identification Data (EDID) specification, which allows displays to communicate with attached systems and provides information about resolution and other display capabilities. The host computer system may, without limitation, send commands to the display device using a protocol such as Monitor Command Control Set (MCCS) such that the host computer can change the behavior of a display device.

Another embodiment provides an apparatus comprising at least one storage device for storing program instructions and at least one processor for processing the program instructions to: receive data from a first display device indicating an orientation of the first display device, receive data from the first display device indicating detection of a second display device in a position adjacent to a first edge of the first display device, determine a layout of the first and second display devices based upon the orientation of the first display and the adjacent position of the second display device relative to the first display device, and automatically configure operating system display settings to identify that the first and second display devices are physically arranged according to the determined layout. The apparatus may be referred to as a computer.

Many display devices are rectangular, whether square or having an aspect ratio (width:height) of 4:3 or greater. Accordingly, first and second display devices may be beneficially positioned side-by-side or one above the other. For example, the adjacent position of the second display device relative to the first display device may be described as being above, below, left or right of the first display device. In this context, the position of the display devices is stated from the perspective of a user viewing the display screens of the first and second display devices. The orientation sensor may, for example, indicate an upward direction, such that a rectangular display device having a predetermined arrangement of detectors along each of the four edges of display device may determine which detector is directed upward, which detector is directed downward, which detector is directed to the right, and which detector is directed to the left. Therefore, a first display device may determine the relative direction of an adjacent second display device using the orientation of the first display device, the predetermined arrangement of the detectors, and a signal indicating which detector has detected the second display device.

In one option, the at least one processor may further process the program instructions to receive data from the second display device indicating an orientation of the second display device, receive data from the second display device indicating detection of the first display device in a position adjacent to a first edge of the second display device, and confirm that the data from the second display device is consistent with the data from the first display device prior to automatically configuring the operating system display settings. For example, if the data from the first display device indicates that it has detected the second display device to the right of the first display device, then the data from the second display device is consistent if it indicates that it has detected the first display device to the left of the second display device. Similarly, if the data from the first display device indicates that it has detected the second display device above the first display device, then the data from the second display device is consistent if it indicates that it has detected the first display device below the second display device. The data from the first and second display devices may found to be inconsistent if, for example, the first display device indicates that it has detected the second display device to the above of the first display device, and the data from the second display device indicates that it has detected the first display device to the left of the second display device. In a generally edge-to-edge, forward-facing physical layout of the display devices, the second display device cannot be both above the first display device and to the right of the first display device.

In a further embodiment of the apparatus, the at least one processor may further process the program instructions to receive data from the first display device indicating detection of a third display device in a position adjacent to a second edge of the first display device, determine a layout of the first and third display devices based upon the adjacent position of the third display device relative to the first display device, and automatically configure the operating system display settings to identify that the first and third display devices are physically arranged according to the determined layout. In fact, the physical layout of any number of display devices may be determined according to the disclosed embodiments. While a single rectangular display device having a detector disposed near each of the four edges may only be able to detect up to four adjacent display devices, each of those adjacent display devices may also be able to similarly detect additional display devices.

In one option, a processor of the first display device may itself perform a determination of a direction of the second display device relative to the first display device using the display device orientation, the predetermined arrangement of detectors on the first display device, and the identity of the particular detector that detected the second display device. Accordingly, the first display device may provide the direction of the second display device to the apparatus. In an alternative option, the at least one processor of the apparatus may further process the program instructions to receive data from the first display device identifying the identity of a first detector that detected the second display device, wherein the first detector is one of a plurality of detectors of the first display device, the plurality of detectors having a predetermined arrangement about a central area of the first display device. Therefore, the apparatus may itself determine a direction of the second display device relative to the first display device based upon the orientation of the first display device, the predetermined arrangement of the plurality of detectors, and the identity of the first detector. It should be appreciated that in either option, the first display device provides sufficient information for the apparatus to determine a physical layout of the display devices.

In embodiments with only first and second display devices, it is not necessary for the first display device to use its detector to obtain the identity of the second display device. In fact, it is not even necessary for the computer to obtain data directly from the second display device. However, in embodiments with more than two display devices, it is preferable for each detector of the first display device to obtain the identity of the adjacent display device that is being detected. The computer may then receive data from the first display device identifying the second display device that was detected adjacent to the first display device. This data enables the computer to determine where each particular display device is located within the physical layout. For example, if the first display device detects an adjacent display device to its right and detects another adjacent display device to its left, then obtaining the identities of the two adjacent display devices enables the first display device to provide the apparatus (host computer) with the identity of the display device on the left and the identity of the display device on the right. Accordingly, the computer is able to automatically configure the display settings so that the computer may correctly communicate a left image to the display device identified as being on the left and correctly communicate a right image to the display device identified as being on the right. The computer may further include a display adapter for communicating with the first and second display devices, wherein the data received from the first display device is received via the display adapter, and wherein the images sent to the first and second display devices are sent via the display adapter.

The operating system display settings are preferable configured to identify each display device that is coupled to the computer, as well as the physical location of each display device with the determined layout of the display devices. Embodiments may further include the selection and designation of a display device as having primary/secondary/etc. status. For example, a primary display device may include certain icons or control features that are not repeated on each of the other display devices coupled to the computer. Optionally, primary status may be automatically assigned to a display device determined to be in predetermined relative position, such as the display device that is in the left-most position of the lowest level of display devices in the layout. Other predetermined relative positions may be used as the basis for automatically assigning primary status, secondary status or any other status.

Yet another embodiment provides a non-transitory computer program product comprising computer readable storage media having program instructions embodied therewith, the program instructions executable by a processor to: receive data from a first display device indicating an orientation of the first display device, receive data from the first display device indicating detection of a second display device in a position adjacent to a first edge of the first display device, determine a layout of the first and second display devices based upon the orientation of the first display device and the adjacent position of the second display device relative to the first display device, and automatically configure operating system display settings to identify that the first and second display devices are physically arranged according to the determined layout.

The foregoing computer program product may further include program instructions for implementing or initiating any one or more aspects of the methods and apparatus described herein. Accordingly, a separate description of the methods and apparatus will not be duplicated in the context of a computer program product.

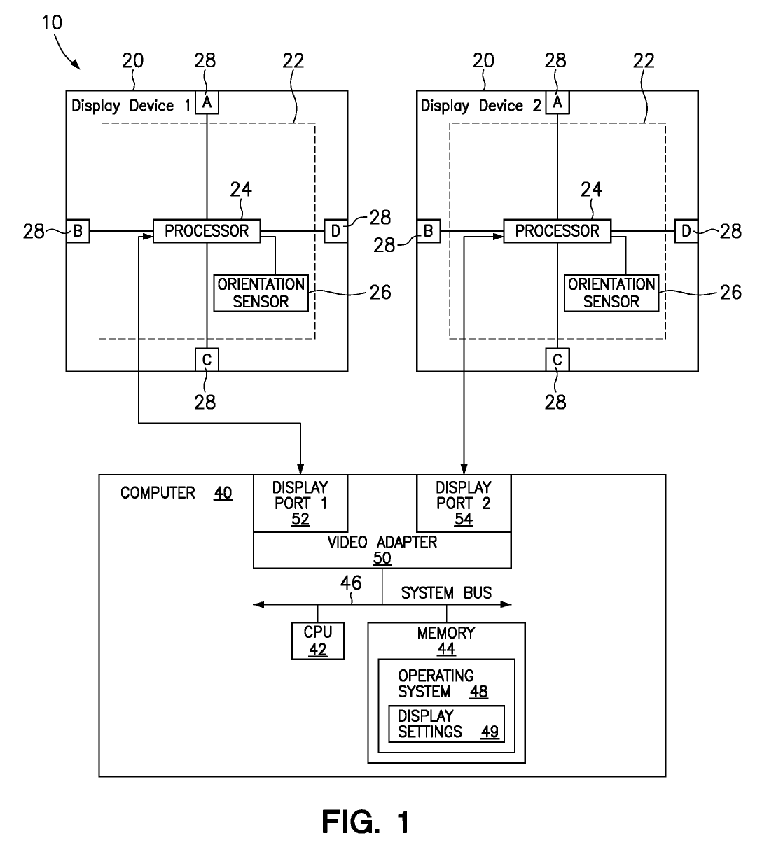

FIG. 1 is a diagram of a system 10 including first and second display devices 20 coupled to a computer 40. Each display device 20 includes a display screen 22 (shown in dashed lines), a processor 24, an orientation sensor 26, and a plurality of detectors 28. The display screen 22, orientation sensor 26 and detectors 28 are each coupled to the processor 24. Each display device 20 may also include a power supply (not shown) for supplying power to the display device.

The computer 40 includes a central processing unit (CPU) 42, memory 44, and a video adapter 50, wherein each of the components 42, 44, 50 are in communication over a system bus 46. The video adapter 50 includes a first display port 52 for coupling to a first display device 20 (Display Device 1) and a second display port 54 for coupling to a second display device 20 (Display Device 2). The operation of the two display devices 20 is controlled, in part, by display setting 49, which may be part of the operating system 48.

During setup of the system 10, the two display devices 20 are physically arranged according to user preferences. During powering on of the display devices 20, or during power-on self-test (POST) or booting of the computer 40, one or more of the display devices 20 may obtain a signal from the orientation sensor 26 and a signal from any of the detectors 28 that detect the presence of an adjacent display device. Preferably, the presence of an adjacent display device 20 may be indicated when a detector 28 of a first display device 20 is able to establish communication with a detector 28 of a second display device 20. Accordingly, the detector 28 of the first display device does not merely detect the presence of some random object or piece of metal, but detects that there is a detector 28 of another display device 20 capable of communicating with the first display device 20. Optionally, an adjacent second display device 20 may or may not be detected by the first display device 20 unless the adjacent second display device 20 has its power is turned on.

Furthermore, the processor 24 of one or more of the display devices 20 may communicate with the computer 40 by sending the current orientation of the display screen and sending an indication of which detector has detected the presence of the adjacent display device. The current orientation may, for example, indicate which portion of the display device is upwardly directed, such that a rectangular display device having a predetermined arrangement of detectors along each of the four edges of display device may determine, or provide the computer with sufficient information to determine, which detector is directed upward, which detector is directed downward, which detector is directed to the right, and which detector is directed to the left. Therefore, a first display device may determine the relative direction of an adjacent second display device using the orientation of the first display device, the predetermined arrangement of the detectors, and a signal indicating which detector has detected the second display device. After configuring the display devices, the computer 40 may send, and the processor 24 of each display device 20 may receive, respective images from the video adapter 50 of the computer in a manner consistent with the display settings 49.

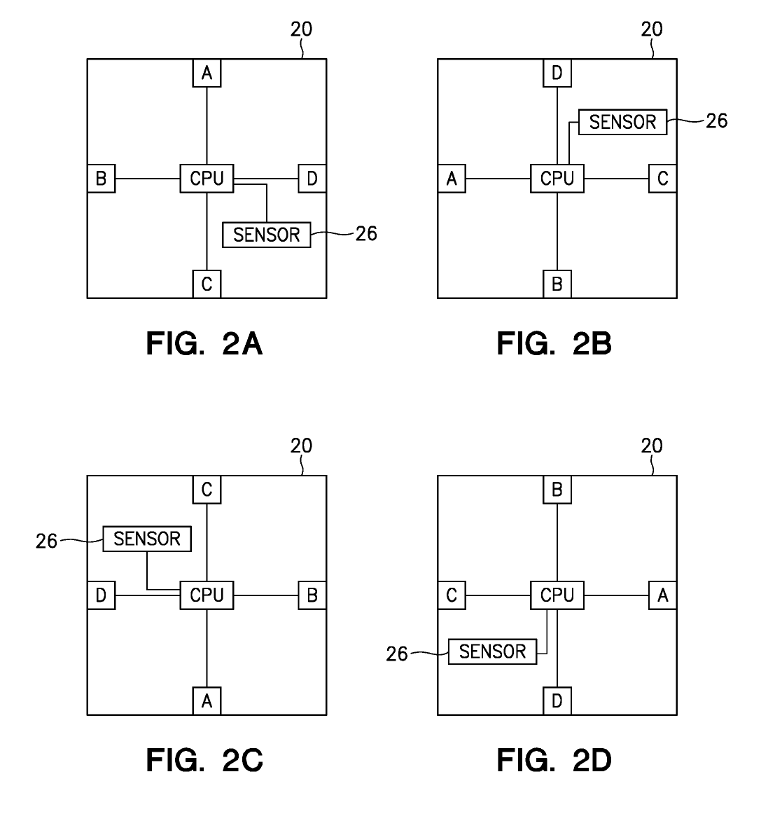

FIGS. 2A-2D are diagrams of a display device 20 in various orientations. FIG. 2A illustrates the display device 20 in a first orientation that is characterized by the detector “A” being disposed in an upward direction. FIG. 2B illustrates the display device 20 in a second orientation that is characterized by the detector “D” being disposed in an upward direction. Similarly, FIGS. 2C and 2D illustrate the display device 20 in third and fourth orientations, respectively, that are characterized by the detector “C” being disposed in an upward direction (FIG. 2C) and the detector “B” being disposed in an upward direction (FIG. 2D). In each of FIGS. 2A-2D, the orientation sensor 26 provides a signal that distinguishes the illustrated orientation of the display device 20 from the orientations illustrated in the other three Figures. Since the detectors A, B, C and D are in a fixed predetermined arrangement about the display device 20, indicating which detector is upward (or any other direction) will necessarily indicate the orientation (up, down, left or right) of each of the other detectors of the individual display device.

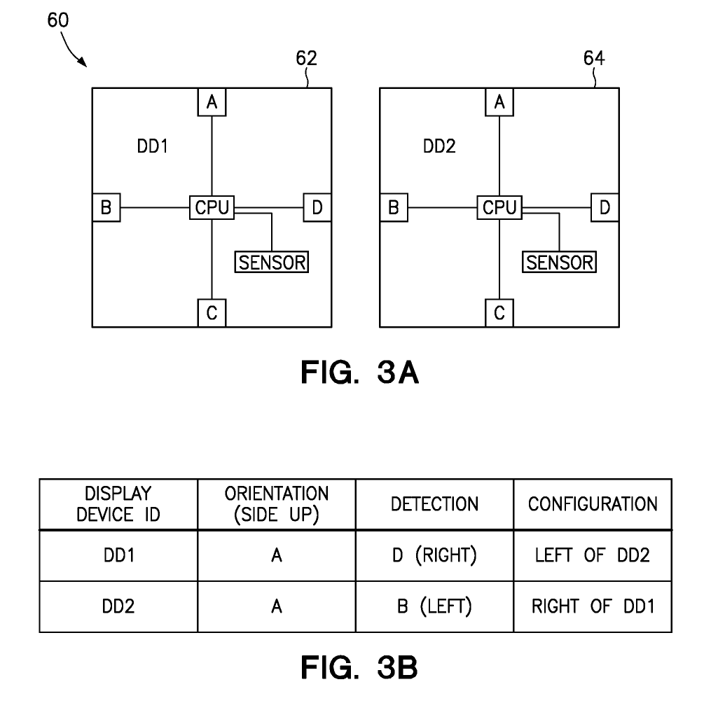

FIG. 3A is a diagram of a first physical layout 60 of a first display device (DD1) 62 and a second display device (DD2) 64. Each display device 62, 64 is rectangular and has detectors A, B, C and D consistent with the display devices 20 shown in FIG. 1. In this example, each display device 62, 64 should be considered to be coupled to a computer (not shown) consistent with FIG. 1.

FIG. 3B is a configuration table representing the layout 60 of the two display devices 62, 64. A first column provides a display device identifier (ID), a second column provides the orientation (identification of the detector that is oriented upward), a third column identifies the detector (and its physical direction) that has detected an adjacent display device, and a fourth column provides a configuration statement that describes a portion of the layout 60. Accordingly, a first row below the header indicates that DD1 has detector A directed upward, such that detector D (which has detected the adjacent DD2) is directed to the right. Therefore, the DD1 is determined to be to the left of DD2. Similarly, a second row of the configuration table indicates that DD2 also has its detector A directed upward, such that its detector B (which has detected the adjacent DD1) is directed to the left. Therefore, the DD2 is determined to be to the right of DD1. Since the configuration statements are consistent (i.e., not in conflict), the configuration table of FIG. 3B accurately and fully characterizes the layout 60 and is saved to the display settings of the operating system for the computer.

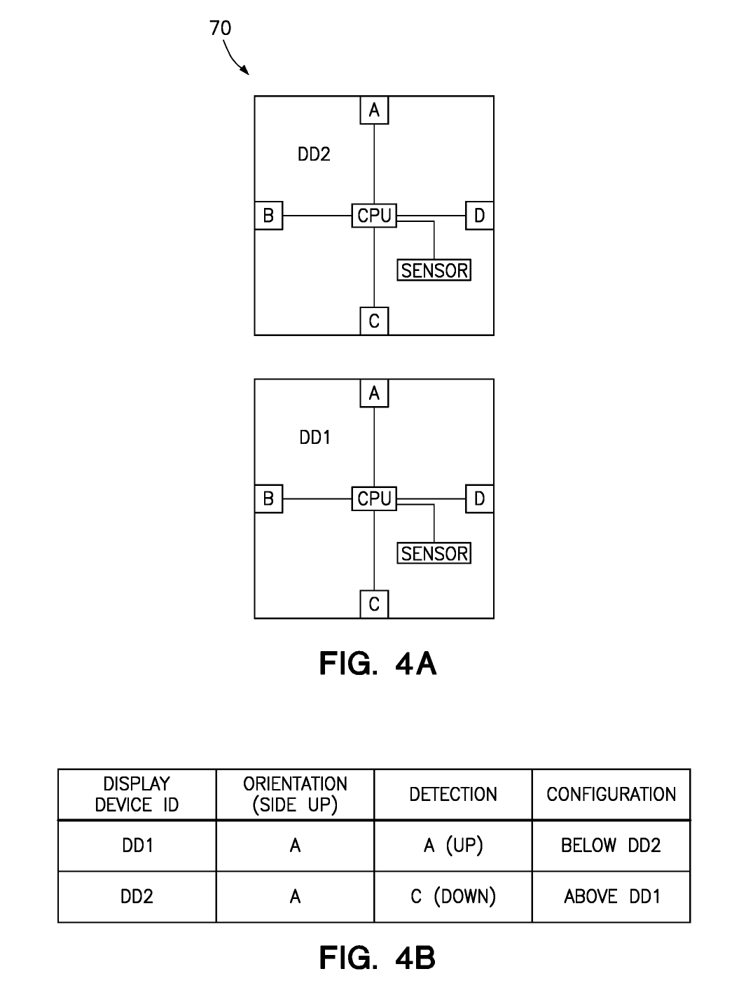

FIG. 4A is a diagram of a second physical layout 70 of a first display device (DD1) 72 and a second display device (DD2) 74. Each display device 72, 74 is rectangular and has detectors A, B, C and D consistent with the display devices 20 shown in FIG. 1. In this example, each display device 72, 74 should be considered to be coupled to a computer (not shown) consistent with FIG. 1, except for the physical arrangement of the display devices.

FIG. 4B is a configuration table representing the layout 70 of the two display devices 72, 74. As in FIG. 3B, the first column provides a display device identifier (ID), a second column provides the orientation (identification of the detector that is oriented upward), a third column identifies the detector (and its physical direction) that has detected an adjacent display device, and a fourth column provides a configuration statement that describes a portion of the layout 70. Accordingly, a first row below the header indicates that DD1 has detector A directed upward, such that detector A (which has detected the adjacent DD2) is directed “up”. Therefore, the DD1 is determined to be below DD2. Similarly, a second row of the configuration table indicates that DD2 also has its detector A directed upward, such that its detector C (which has detected the adjacent DD1) is directed “down”. Therefore, the DD2 is determined to be above DD1. Since the configuration statements are consistent (i.e., not in conflict), the configuration table of FIG. 4B accurately and fully characterizes the layout 70 and is saved to the display settings of the operating system for the computer.

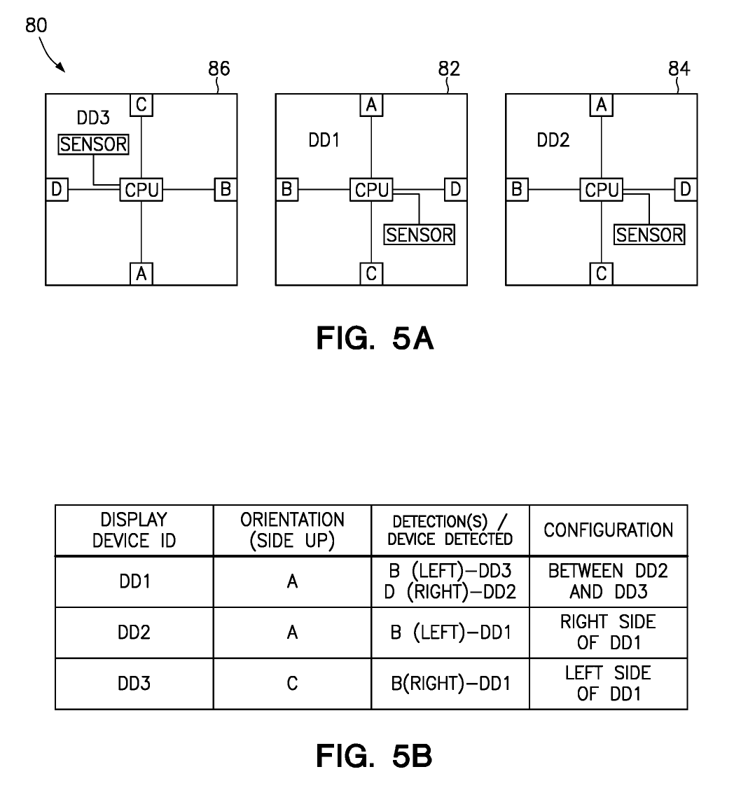

FIG. 5A is a diagram of a physical layout 80 of a first display device (DD1) 82, second display device (DD2) 84, and third display device (DD3) 86. Each display device 82, 84, 86 is rectangular and has detectors A, B, C and D consistent with the display devices 20 shown in FIG. 1. In this example, each display device 82, 84, 86 should be considered to be coupled to a computer (not shown) consistent with FIG. 1, except for the number and physical arrangement of the display devices.

FIG. 5B is a configuration table representing the layout 80 of the three display devices 82, 84, 86. The first column provides a display device identifier (ID), a second column provides the orientation (identification of the detector that is oriented upward), a third column identifies the detector (and its physical direction and display device detected) that has detected an adjacent display device, and a fourth column provides a configuration statement that describes a portion of the layout 80.

Accordingly, a first row below the header indicates that DD1 has detector A directed upward, such that detector B has detected the adjacent DD3 to the “left” and the detector D has detected the adjacent DD2 to the “right”. Therefore, the DD1 is determined to be horizontally between DD2 and DD3.

Similarly, a second row of the configuration table indicates that DD2 also has its detector A directed upward, such that its detector B has detected the adjacent DD1 to the “left”. Therefore, DD2 is determined to be to the right side of DD1.

Still further, a third row of the configuration table indicates that DD3 has its detector C directed upward, such that its detector B has detected the adjacent DD1 to the “right”. Therefore, DD2 is determined to be to the left side of DD1. Since the configuration statements in all three rows are consistent (i.e., not in conflict), the configuration table of FIG. 5B accurately and fully characterizes the layout 80 and is saved to the display settings of the operating system for the computer.

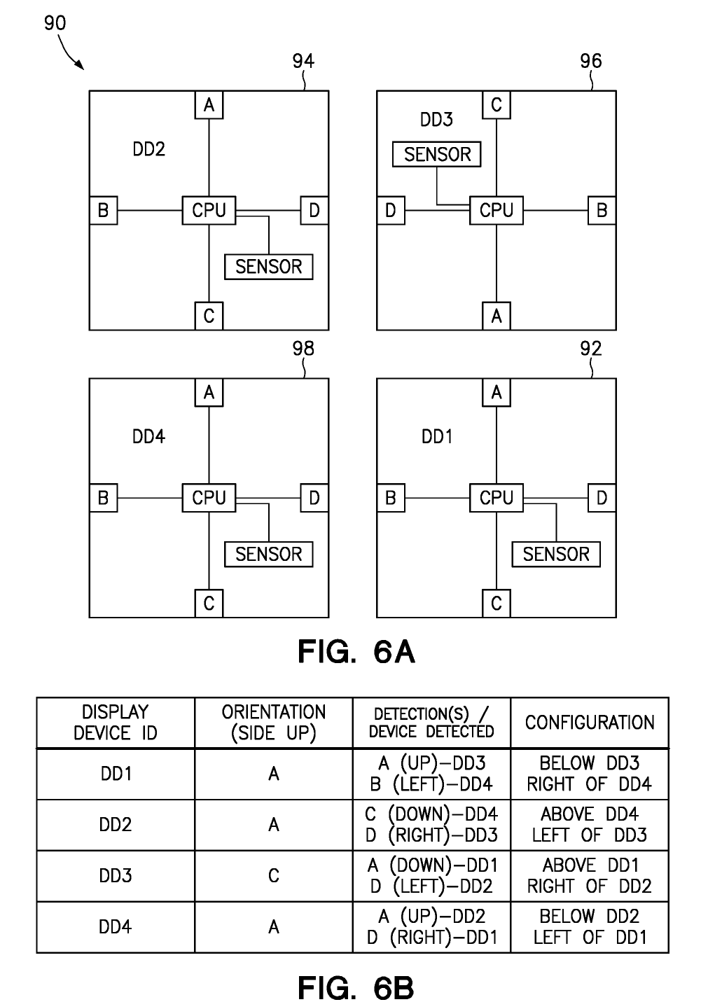

FIG. 6A is a diagram of a physical layout 90 of a first display device (DD1) 92, second display device (DD2) 94, third display device (DD3) 96, and fourth display device (DD4) 98. Each display device 92, 94, 96, 98 is rectangular and has detectors A, B, C and D consistent with the display devices 20 shown in FIG. 1. In this example, each display device 92, 94, 96, 98 should be considered to be coupled to a computer (not shown) consistent with FIG. 1, except for the number and physical arrangement of the display devices.

FIG. 6B is a configuration table representing the layout 90 of the four display devices 92, 94, 96, 98. The first column provides a display device identifier (ID), a second column provides the orientation (identification of the detector that is oriented upward), a third column identifies the detector (and its physical direction and display device detected) that has detected an adjacent display device, and a fourth column provides a configuration statement that describes a portion of the layout 90.

Accordingly, a first row below the header indicates that DD1 has detector A directed upward, such that detector A has detected the adjacent DD3 “above” and the detector B has detected the adjacent DD4 to the “left”. Therefore, the DD1 is determined to be below DD3 and to the right of DD4.

A second row of the configuration table indicates that DD2 also has its detector A directed upward, such that its detector C has detected the adjacent DD4 to the “below” and detector D has detected the adjacent DD3 to the “right”. Therefore, DD2 is determined to be above DD4 and to the left of DD3.

A third row of the configuration table indicates that DD3 has its detector C directed upward, such that its detector A has detected the adjacent DD1 “below” and detector D has detected adjacent DD2 to the “left”. Therefore, DD3 is determined to be above DD1 and to the right of DD2.

A fourth row of the configuration table indicates that DD4 has its detector A directed upward, such that detector A has detected the adjacent DD2 “above” and detector D has detected adjacent DD1 to the “right”. Therefore, DD4 is determined to be below DD2 and to the left of DD1.

Since the configuration statements in all four rows are consistent (i.e., not in conflict), the configuration table of FIG. 6B accurately and fully characterizes the layout 90 and is saved to the display settings of the operating system for the computer.

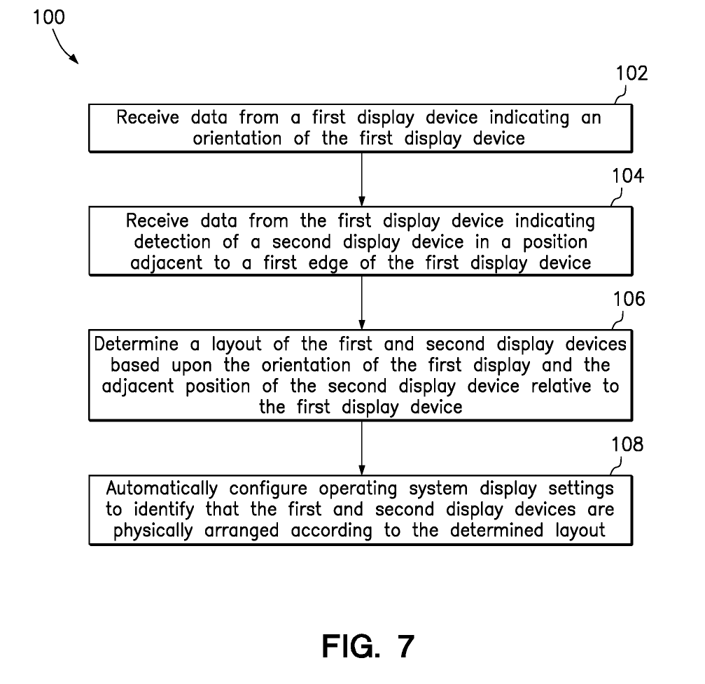

FIG. 7 is a flowchart of a method or program instructions 100 for execution by a processor of a computer according to one embodiment. In step 102, the computer receives data from a first display device indicating an orientation of the first display device. In step 104, the computer receives data from the first display device indicating detection of a second display device in a position adjacent to a first edge of the first display device. In step 106, the computer determines a layout of the first and second display devices based upon the orientation of the first display and the adjacent position of the second display device relative to the first display device. In step 108, the computer automatically configures operating system display settings to identify that the first and second display devices are physically arranged according to the determined layout.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A display device, comprising
a display screen for displaying images received from a computer;
an orientation sensor for determining a current orientation of the display screen;
a plurality of detectors spaced apart about a central portion of the display screen at predetermined positions, each detector for detecting presence of an adjacent display device; and
a processor in communication with the orientation sensor, the plurality of detectors, and an input/output port, the processor for sending the current orientation of the display screen, sending an indication of which detector has detected the presence of the adjacent display device, and receiving the images from the computer.

2. The display device of claim 1, wherein the plurality of detectors are disposed along a perimeter of the display screen.

3. The display device of claim 1, wherein the display screen is rectangular, and wherein the plurality of detectors include a detector disposed adjacent each edge of the rectangular display screen.

4. The display device of claim 1, wherein the detectors are non-contact detectors.

5. The display device of claim 4, wherein the non-contact detectors are selected from near field communication devices and ultra high frequency radio wave devices.

6. An apparatus, comprising:
at least one storage device for storing program instructions; and
at least one processor for processing the program instructions to:
receive data from a first display device indicating an orientation of the first display device;
receive data from the first display device indicating detection of a second display device in a position adjacent to a first edge of the first display device;
determine a layout of the first and second display devices based upon the orientation of the first display and the adjacent position of the second display device relative to the first display device; and
automatically configure operating system display settings to identify that the first and second display devices are physically arranged according to the determined layout.

7. The apparatus of claim 6, wherein the adjacent position of the second display device relative to the first display device is selected from above, below, left and right.

8. The apparatus of claim 6, the at least one processor for further processing the program instructions to:
receive data from the second display device indicating an orientation of the second display device;
receive data from the second display device indicating detection of the first display device in a position adjacent to a particular edge of the second display device; and
confirm that the data from the second display device is consistent with the data from the first display device prior to automatically configuring the operating system display settings.

9. The apparatus of claim 6, the at least one processor for further processing the program instructions to:
receive data from the first display device indicating detection of a third display device in a position adjacent to a second edge of the first display device;
determine a layout of the first and third display devices based upon the adjacent position of the third display device relative to the first display device; and
automatically configure the operating system display settings to identify that the first and third display devices are physically arranged according to the determined layout.

10. The apparatus of claim 6, wherein the data received from the first display device indicating detection of a second display device in a position adjacent to a first edge of the first display device, includes data indicating a direction of the second display device relative to the first display device.

11. The apparatus of claim 6, the at least one processor for further processing the program instructions to:
receive data from the first display device identifying the identity of a first detector that detected the second display device, wherein the first detector is one of a plurality of detectors of the first display device, the plurality of detectors having a predetermined arrangement about a central area of the first display device;
determine a direction of the second display device relative to the first display device based upon the orientation of the first display device, the predetermined arrangement of the plurality of detectors, and the identity of the first detector.

12. The apparatus of claim 6, the at least one processor for further processing the program instructions to:
receive data from the first display device identifying the second display device that was detected adjacent to the first display device.

13. The apparatus of claim 6, the at least one processor for further processing the program instructions to:
send images to the first and second display devices as a function of the display settings.

14. The apparatus of claim 13, further comprising:
a display adapter for communicating with the first and second display devices, wherein the data received from the first display device is received via the display adapter, and wherein the images sent to the first and second display devices are sent via the display adapter.

15. A computer program product comprising non-transitory computer readable storage media having program instructions embodied therewith, the program instructions executable by a processor to:
receive data from a first display device indicating an orientation of the first display device;
receive data from the first display device indicating detection of a second display device in a position adjacent to a first edge of the first display device;
determine a layout of the first and second display devices based upon the adjacent position of the second display device relative to the first display device; and
automatically configure operating system display settings to identify that the first and second display devices are physically arranged according to the determined layout.

16. The computer program product of claim 15, wherein the adjacent position of the second display device relative to the first display device is selected from above, below, left and right.

17. The computer program product of claim 15, wherein the program instructions are further executable by the processor to:
receive data from the second display device indicating an orientation of the second display device;
receive data from the second display device indicating detection of the first display device in a position adjacent to a particular edge of the second display device; and
confirm that the data from the second display device is consistent with the data from the first display device prior to automatically configuring the operating system display settings.

18. The computer program product of claim 15, wherein the data received from the first display device indicating detection of a second display device in a position adjacent to a first edge of the first display device, includes data indicating a direction of the second display device relative to the first display device.

19. The computer program product of claim 15, the at least one processor for further processing the program instructions to:
receive data from the first display device identifying the identity of a first detector that detected the second display device, wherein the first detector is one of a plurality of detectors of the first display device, the plurality of detectors having a predetermined arrangement about a central area of the first display device;
determine a direction of the second display device relative to the first display device based upon the orientation of the first display device, the predetermined arrangement of the plurality of detectors, and the identity of the first detector.

20. The computer program product of claim 15, the program instructions executable by a processor to:
receive data from the first display device identifying the second display device that was detected adjacent to the first display device.
